(19) United States
(12) Patent Application Publication
(10) Pub. No.: US 2008/0288437 A1
(43) Pub. Date: Nov. 20, 2008

(54) Perspective-based knowledge structuring & discovery agent guided by a maximal belief inductive logic

(76) Inventor: Edouard Siregar, Owings Mills, MD (US)

Correspondence Address: NATH & ASSOCIATES, 112 South West Street, Alexandria, VA, 22314, US

(21) Appl. No.: 11/798,834

(22) Filed: May 17, 2007

(51) Int. Cl. G06F 17/00

(52) U.S. Cl. 706/50

(57) ABSTRACT

An inductive logic discovery process provides collective knowledge repository uniquely structured as a representative of a collection of knowledge elements in which representations, from which contexts are derived. The contexts lead to specific perspectives, and each perspective offers a specific point of view from which to study an idea. A convergent problem solving function associates a problem situation with problem solving activity in terms of strategy and tactics. The inductive logic is implemented to resolve the problem solving activity into an optimal form of creativity according to the desired degree of specificity of discovery with respect to creativity and logical strength. The maximum belief inductive logic provides the heuristics according to a desired bias toward maximally strong logical bridges and more creative logical bridges.

### FIELD OF THE INVENTION

This invention relates to logic based search engines and more specifically to search engines implementing a discovery method.

### BACKGROUND OF THE INVENTION

In supercomputer simulations, the solutions output often look as complex as the equations that spawn them. A lot of time is spent thinking about how to organize and process scientific knowledge to create new knowledge. This is creativity and discovery guided by inductive logic.

It is desired to use the techniques of computer modeling, computing, and knowledge creation in order to organize and process knowledge as an aid to innovation and discovery. Accordingly, it is desired to create a logical knowledge architecture. Such an architecture could:
collect insights that facilitate creativity and discovery;
collect insights that facilitate problem solving;
enable multiple perspectives and representations of ideas; and
encourage metaphorical and analogical thinking about ideas.

Knowledge structures are provided that enable maximal creativity and discovery by allowing any knowledge domain to contribute to any given idea. The discovery is made to favor cross-disciplinary fertilization, and allow any agent (human or artificial) with the required knowledge field to contribute to creative insights, in terms of collective contribution.

Cooperative work can be implemented by the sharing of ideas. This allows collective cooperation on making useful insights more available and structured. Human-computer cooperation can be used in a way that maximizes the strengths of each, and mutually eliminates their weaknesses. It is desired to enable cooperation by cooperation, achieved by providing a logically structured collective knowledge repository and designed specifically for creative invention and discovery, thereby enabling cooperation for innovation/problem solving. One concept in algorithmic information theory and metamathematics as an interpretation of Godel's incompleteness theorem is that a static fixed formal axiom system cannot work. It is therefore intended to provide a technique to provide new information and concepts.

There exist a number of search and discovery techniques; however, there is still a need for new tools for creative invention and discovery. There is also a strong trend towards large scale cooperative endeavors such as Wikipedia, Helium, YouTube, Human Genome Project, Amazon AAI, Mechanical Turk, MySpace, Linux, etc.

In general, a search can be made based on an idea or a fact, and the idea is extrapolated, for example by keywords. This can be effective but is constrained by the existing patterns of association of a given field of search. A general approach to searching is to take a basic term or concept and collect data which includes the term, with a target being to confine the search to more precisely defined results. The dynamics of such an approach is to attempt to define an idea or an area of exploration, and go from the defined idea to a more concrete result. In practical terms, one would define a search, for example by the use of keywords, and attempt to narrow the results of the search to that which is defined by the keywords. This approach is generally effective; however, it tends to be intellectually incestuous from a discovery standpoint, and is more useful for determining known or pre-existing relationships. The most effective use of such a strategy is an attempt to identify a pre-established concept.

### SUMMARY

In one aspect, a technique is used for storing a knowledge repository having uniform structured environments of representations and perspectives. A name of an idea is input, a lexicon of domains is displayed and a name of a domain of the idea from a lexicon of domains is input. A modified name of a domain may be read, in which the modified name contains the idea.

In a further aspect, the idea is selected, a first characteristic class of the idea is identified, and at least a second characteristic class of the idea is identified. The name of the domain is identified, based on the identified first characteristic class of the idea and the identified second characteristic class of the idea. A first characteristic class of the idea as a general classification of and a second characteristic class of the idea as a modifier of may be identified. This may be implemented by selecting the idea, identifying a context of the idea, identifying a perspective of the idea, and selecting the name of the domain based on the identified first context class of the idea and the identified perspective of the idea.

In another aspect, a technique is used for exploring a knowledge repository having uniform structured environments of representations and perspectives. A term is selected, and a conceptual representation for the term is input. A perspective from which to study the term within the representation is provided and the representation is classified within a domain. A metaphor from the representation for the perspective is extracted and used to generate an analog from the domain.

This may be implemented by using an analogy or inductive inference to select a conclusion statement from a premise statement set within the domain, and using a logic strategy within a class of plausibility strategies. The strategies are selected from strategies having different inductive probabilities. These strategies may be selected from a greatest inductive probability, that equates to a weakest conclusion a weakest statement Q=Qmin within all domain instances, a statement Q=Qmax with a greatest multi-domain validity as a simple induction argument component a conclusion as the disjunction (OR) of all statements, maximum specificity strategies such that the maximum specificity strategies equal a lowest inductive probability and a strongest conclusion, a strongest statement Q=Qmax within all domains, a statement Q=Qmin with lowest multi-domain presence, and/or a conclusion as the conjunction (AND) of all statements.

In a further aspect, an apparatus is provided that is capable of addressing a knowledge repository having uniform structured environments of representations and perspectives, and exploring stored knowledge repository data having uniform structured environments of representations and perspectives. The apparatus provides a routine for at least one of selecting or inputting a term, a routine for at least one of accepting an input of a domain or displaying a domain, and a routine for establishing a lexicon association between and one or more domains associated with the term.

### BRIEF DESCRIPTION OF THE DRAWINGS

FIG. 1 is a diagram depicting the concept of a transition between source ideas and target ideas.

FIG. 2 is a diagram showing a structure used to transition from source ideas and target ideas.

FIG. 3 is a diagram showing a logical interface between a user and a discovery agent.

FIG. 4 is a diagram describing a logical data flow between a stated problem and focus and an expression of domain strategies and tactics.

### DETAILED DESCRIPTION

### Overview

The logic of the present subject matter provides a cooperative innovation engine, responding to two fundamental global economic needs E1, E2 as follows:
(E1) A need for new innovation tools in the global economy in which many skills are fungible, but in which a high premium is placed on research and innovation. Innovation becomes an increasingly important source of income for the more advanced nations in the global economy.
(E2) A new disruptive paradigm of “mass cooperation”, exemplified by wikinomics of Linux, Human Genome Project, YouTube, MySpace, Google, Wikipedia, Helium, and Amazon AAI.

In order to achieve discovery, the technique is used whereby a narrow concept is expanded to an abstract concept, thereby going from a basic idea to a less concrete idea. One takes a term T, inputs a conceptual representation R for the term T, provides a perspective P(T) from which to study T within R, classifies the representation R within a domain D, extracts a metaphor M from R for P(T), and uses the metaphor to generate an analog from the domain D.

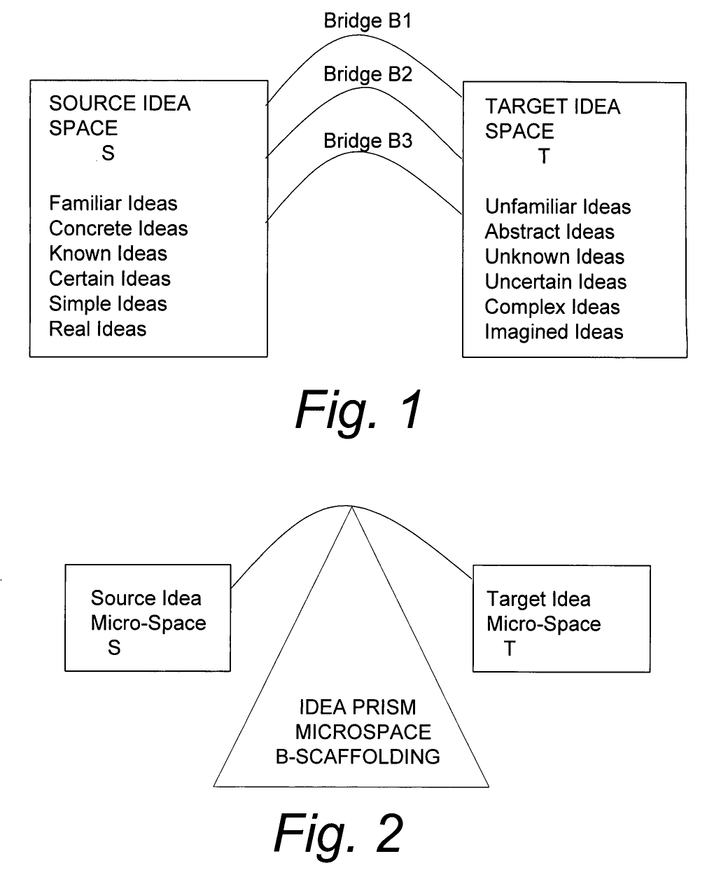

By doing so, E1, E2 are achieved by solving a creativity and discovery problem (CP). CP then becomes the common core of innovation, invention and discovery endeavors. An example representation of CP is depicted in FIG. 1, in which a source idea space S is used to provide a target idea space T.

In FIG. 1, the creativity and discovery problem (CP) is to build a set B of mental bridges connecting:
(a) The real S, to the imagined T
(b) The familiar S, to the unfamiliar T
(c) The concrete S, to the abstract T
(d) The simple S, to the complex T
(e) The certain S, to the uncertain T
(f) The known S, to the unknown T

As can be seen, the bridges B link two spaces of ideas: S (source) and T (target). While three bridges are depicted, the concept is to provide enough bridges to provide a significant transition from the source idea space S to the target idea space T. Typically, the bridges are simultaneously used for a creative thought or invention. The technique enables this construction of parallel bridges B to solve CP without the impossible construction of the immense ill-defined spaces S and T themselves.

The technique guides the creativity and discovery process by the use of inductive logic. The inductive logic ensures that the bridges B have high (inductive) strength.

The most potent and natural mental tools we have are bridges B between spaces S and T. Three of the most important classes of bridges we have are B1, B2 and B3:
(B1) Multiple Representations, Contexts, Perspectives
(B2) Parallel Multi-Domain Metaphors M(S) for T
(B3) Deep Analogies linking S and T

The bridges B={(B1), (B2), (B3)} enable the mind to move from known familiar source ideas S, to unfamiliar novel ideas T under exploration. It is advantageous to implement the technique by computer because with a large database, it becomes extremely difficult to accomplish this without the aid of a computer. The technique provides bridges for solving the problem CP. The technique satisfies two fundamental “maximal creativity and discovery” requirements:
1. All domains S of knowledge can participate in cross-fertilizing any given idea T under creative exploration; and
2. Any agent (human or artificial) with the relevant knowledge can participate in the creative process.

The technique enables maximal creativity and discovery for solving CP by providing a large space of idea contexts where cross-fertilizing of ideas occurs, as well as an interface for allowing participation. This provides cooperative innovation logic, enabling all agents of all skill domains to participate in collective creativity and discovery.

### Maximum Belief Inductive Logic:

Maximum belief inductive logic is used:
(a) to structure a process ontology (max specificity of perspectives), called IDEA;
(b) to guide all of the agent's activities; and
(c) to make the mental bridges as logically strong as possible.

### Idea Decomposition

As used herein, IDEA serves as a combination process ontology and discovery knowledge base (DKB). The acronym “IDEA”, represents “Idea DEcomposition via Abstraction”. IDEA is used as a representation language for resolving T, and is considered a high level ontology because it is abstract and because it is a process ontology.

FIG. 2 is a diagram showing a structure used to transition from source ideas to target ideas. The technique is used to transition from a source idea microspace S to a target idea microspace T. This provides a knowledge management tool, addressing the problem common to all invention and discovery activity.

The common core in all invention and discovery activity is the “Creativity Problem” (CP). Stated another way, the Creativity Problem (CP) is to construct a set of mental bridges B, enabling someone to:
(1) Explore an imagined idea T, using real knowledge S
(2) Explore an unfamiliar idea T, using familiar knowledge S
(3) Explore an abstract idea T, using concrete knowledge S
(4) Explore a complex idea T, using simple knowledge S
(5) Explore an uncertain idea T, using certain knowledge S
(6) Explore an unknown idea T, using known knowledge S

Typically, operations {(1), . . . , (6)} are all simultaneously needed for a single creative exploration (e.g., T=a new strategy or a new behavior). The technique helps to cope with this difficult demand.

A set B of parallel bridges are needed to satisfy the simultaneous CP operations {(1), . . . , (6)}. While six bridges are discussed herein, any number of bridges (more or less than six) may be needed. The nature of the bridges depend on the kind of creativity meant. The technique focuses on creativity that respects that which is already known (no wheel re-inventions), and builds upon it (building on the shoulder of giants). This is the kind of creativity needed in science, engineering, medicine, business, architecture, and also in art, music, literature etc.

In addition, we require that all domains of human knowledge may simultaneously participate to creativity in any given domain. Domain cross-fertilization is a key requirement of the strategy.

As a last fundamental condition, it is required that the technique enables cooperative creativity, where any agent (human or eventually artificial intelligence), with the right knowledge can participate in the creativity process.

To accomplish all its invention and discovery tasks, the technique uses two main tools:
(a) IDEA, which is the combination process ontology and discovery knowledge base (DKB);
(b) A strategy called the maximum belief inductive logic.

The technique provides the logic guiding an optimal form of creativity: the creation of mental bridges with maximum logical strength. The technique uses an IDEA, as shown in FIG. 2 and the maximum belief inductive logic to build the bridges B that move the mind from known source ideas S, to a target idea T, in a logically optimal way. The technique solves the Creativity Problem (CP), by enabling an agent (human or artificial) to build the set of bridges B={B1, B2, B3}, by providing optimal bridge-building rules (heuristics adapted to local contexts).

For its bridge-building, the technique proceeds in three sequential steps (which can be iterated):
(B1) Select a representation R of T, and a perspective P within it;
(B2) Generate parallel multi-domain metaphors about T; and
(B3) Generate deep analogies related to T.

Instead of attacking the idea T directly, the technique first uses an IDEA to split T into component perspectives P, within well-defined cognitive contexts C, and representations R. Each perspective P(T) offers a unique representation language for exploring T.

The decomposition aspect of IDEA is achieved by implementation of multiple roles in solving CP:
(1) Universality: Any knowledge domain Di must be able to be represented by the perspectives P in IDEA. Universality enables all knowledge domains to participate in generating metaphors and analogs.
(2) Fertilization: Universality allows all knowledge domain to participate and cross-fertilize each other via parallel metaphor and analogy bridges that enrich T.
(3) Completeness: Multiple aspects of an idea must be represented so that no essential element is missing. When thinking about an idea, we often get stuck into one or two main representations. Complex ideas can require dozens of representations to be fully understood.
(4) Specificity: IDEA perspectives P(T) must be specific enough to focus the questioning and exploration of T. Exploring perspectives P(T) of T, rather than T directly, is a divide and conquer strategy: exploring specific aspects of an idea sharpens the thinking and questioning about T.
(5) Logical Strength: Inductive strength is proportional to the strength (specificity) of the premise statements. The specification of an idea T into representation R, and a perspective P(T) within R, endow the inductive arguments with strength. The inductive arguments' conclusions have a higher inductive probability than arguments about T directly.
(6) Simplification: when it comes to simplicity, not all idea representations are equivalent. Some prove much simpler than others. For example a fractal is complex from the geometric perspective, but simple from the perspective of iterations. Some representations will greatly simplify the exploration of ideas T.

### IDEA Graph Structure

IDEA is a process ontology as opposed to a domain ontology. The process IDEA addresses is invention and discovery. The backbone of IDEA can be represented by a mathematical graph, with nodes and edges. The purpose of IDEA is to provide local contexts C, where ideas from multiple domains can cross-fertilize via metaphors and analogies.

The technique solves CP, by using a small well-defined (mathematically) space I=IDEA, connecting small subsets of the vast and ill-defined spaces S (source ideas) and T (target idea under exploration) (see. FIG. 2).

In this manner, the technique never deals directly with huge ill-defined spaces S and T (other approaches choose to study micro-domains), but only with tiny subspaces of S and T. The technique only deals with a compact, well-defined space I.

In contrast to successful academic approaches to induction and analogy (e.g., Copycat, Tabletop, Metacat of IU's Fluid Analogies Research Group), the subspaces used are not micro-domains within S and T, but the few most useful elements within the many domains in S and T.

This idea space reduction is possible because:
(a) Not all knowledge in spaces S and T are of equivalent value, for the purpose of generating metaphors and analogies. In particular, some elements of S are valuable while most elements of S are not valuable; and
(b) Only a few metaphors and analogies are needed to be useful. Not the set of all possible metaphors and analogies.

Mathematically, IDEA is a space I, with a topological structure of a graph defined by minimum spanning trees, its minimum spanning forest, plus additional edges E connecting some tree nodes.

The purpose of IDEA is to provide local contexts C, where ideas {Si} from multiple domains {Di}, can cross-fertilize via parallel multi-domain metaphors M and deep analogies.

IDEA is implemented by splitting any given idea T into its component conceptual abstractions, or “colors”. These conceptual abstractions or “colors” are representations R, contexts C, and perspectives P.

Two fundamental requirements for the space I are:
(1) Universality=ideas from any knowledge domain Di can be represented by combinations of representations Rj of R; and
(2) Completeness=all aspects of idea T are properly covered by R.

A simple idea T may require only a single representation, while a complex one requires several representations to describe it. Each representation captures a broad aspect of the complex idea T.

As indicated above, IDEA is represented by a mathematical graph I, composed of nodes and edges. The graph I is represented by N (N<60) minimum spanning trees Rj. So I={Rj; j=1, . . . , N; E=connector edges}.

Each tree Rj represents an abstract fundamental category, such as Space, Time, Process, Symmetry, etc. Each tree is called a Representation, because it captures a broad aspect Rj(T) of any idea T. For example, the time representation Time(T) describe the temporal aspects of T.

By projecting T into multiple representations R={Rj(T); j=1, . . . , n<N}, the unfamiliar, abstract, uncertain, unknown, imagined idea T, becomes more specific, concrete, simple.

Each representation Rj (I spanning tree) holds many contexts C and perspectives P within it. Contexts and perspectives are more concrete specifications of their coarse root representation Rj. For example, the representation Rj=Symmetry is abstract and vague, whereas the perspective P=“4-Fold Symmetry” in the context C=“Symmetry/2D Symmetry” is more concrete (yet abstract enough to represent symmetry ideas from any knowledge domain).

Any idea T requires some relevant set R={Rj} of representations Rj for an adequate representation. For example, a pure “process” such as T=“Evaporation” may require only one dimension Rj=“Process”. But a complex idea such as T=“Pandemic” requires several representations such as Rj=“Dynamics”, Rj+1=“Process”, Rj+2=“State”, Rj+3=Time etc.

The spanning tree leaves Si are metaphor elements. Each perspective P within a representation Rj, holds a set M={Si(Di)} of Parallel Multi-Domain Metaphors for P(T). Each element Si of knowledge domain Di, is a metaphor for T, and each P(Si) a metaphor for P(T).

Thus, each IDEA perspective P (graph node), has a set M(P)={Si} of leaves attached to it. Each leaf Si is a key element of a knowledge domain Di, that is a metaphor for T, from the perspective of P. The set M(P) thus holds multi-domain metaphors for P(T).

To summarize, the graph I is spanned by a forest of spanning trees {Rj}. Each representation Rj holds many perspectives P. The path from a tree root R to a perspective P, forms a context C. This is symbolized as C=R/P. In addition, each spanning tree Rj in I, holds contexts C, where ideas Si from domains Di, cross-fertilize via parallel multi-domain metaphors M(P) for P(T), and analogies derived from M(P).

### IDEA Content

The decomposition component of IDEA is a decomposition of an idea T into component perspectives P(T). This is the first (B1) of three steps in the maximum belief inductive logic solution to the CP. Steps B2 and B3 are:
(B2) constructing Parallel Multi-Domain Metaphors of T; and
(B3) constructing Deep analogies about T.

B2 requires each perspective P to be able to accommodate any knowledge domain Di, to be able to hold multi-domain metaphors M(P) within it. Each perspective (and thus any node in I=IDEA) must be abstract enough to transcend any specific knowledge domain Di, and hence IDEA decomposition via “abstraction”.

The lexicon forming IDEA concepts (graph nodes) is required to be abstract enough to accommodate concepts from any knowledge domain Di. Hence, all IDEA concepts are required to be trans-domain (abstract), to allow perspectives P that accommodate any knowledge domain Di.

Only the tree leaves Si, attached to tree twigs P, are domain specific. The twigs P are abstract, yet as specific as possible, without becoming domain dependent. Maximum specificity of P is part of the maximum belief inductive logic strategy to maximize the strength of the analogy's premises (thus maximizing the inductive strength of the analogical argument). The set of tree leaves constitute the cooperatively growing Discovery Knowledge Base (DKB), attached to the static IDEA ontology (trees).

A context C in I, is defined by the shortest graph (spanning tree) path, from the root Rj of a given spanning tree (a fundamental representation), to the chosen perspective P. C is a context for the perspective P, within which all maximum belief inductive logic statements are interpreted.

The broadest, most abstract element of the context C is the tree root R, a fundamental representation (among I's N representations). Each 1-edge step up the tree becomes more specific and concrete. The perspective P, at the end of the path C, is the most specific and concrete concept within C.

Mathematically, IDEA is a space I, with a topological structure of a graph defined by its minimum spanning trees. IDEA is represented by a graph I containing the set R of basic representations, plus a set E of edges linking the minimal spanning trees in
R: I={R, E}.

A non-limiting example list of a fundamental set of representations for
R={Rj; j=1, . . . , N}for IDEA are:
R01=Behavioral
R02=Categorical
R03=Causal
R04=Complexity
R05=Computation
R06=Constraint
R07=Dynamical
R08=Functional
R09=Game
R10=Geometry
R11=Information
R12=Interaction
R13=Law
R14=Logical
R15=Material
R16=Measure
R17=Model
R18=Motion
R19=Network
R20=Number
R21=Pattern
R22=Probability
R23=Problem
R24=Process
R25=Property
R26=Representation
R27=Scales
R28=Spatial
R29=State
R30=Statistical
R31=Strategy
R32=Structure
R33=Symmetry
R34=Temporal
R35=Transformation

Currently N=35, but this number need not be absolutely fixed. This is in part a matter of convenience (more trees, less tree depth) and will be optimized according to particular configurations of the representations.

The representation R23=Problem, interfaces with the technique's modules which provide a cooperative problem solving function. This module, is called the “cooperative problem solver module”, or CoSolver. This part of the technique focuses on convergent thinking, rather than on divergent innovative thinking.

A few additional dimensions can be added, but the total number N will remain N<60 trees. Another aspect is that each tree be structured according to specifications of Section II.

Two fundamental requirements on the spanning forest set R are:
(1) Universality=ideas from any knowledge domain Di can be adequately represented by combinations of elements Rj of R; and
(2) Completeness=all fundamental aspects of idea T are properly covered by R. “Fundamental” is used to describe aspects covering all mental models of T accepted as scientific.

These are empirical issues (not logical ones), and can only be empirically supported or refuted. The choice is to some extent a matter of simplicity.

An indirect empirical proof is: if R did not have properties (1), (2) then we could find a domain or idea T that violates one or both conditions. If either (1) or (2) are empirically refuted, new items can and will simply be added (but not many since the current Rj are so fundamental to any mental model of an idea T, that few others as fundamental exist).

IDEA space I, is connected (via edges E) to two others in the technique:
K=Kernel: Core representations of math, logic, physics to which IDEA nodes can refer to (with graph edges);
D=Domain Maps: domain knowledge serving as bridges between specialized knowledge, and IDEA nodes. D serves as an introduction to IDEA using suggested initial exploration paths.

### Geometry of Solving the Creativity Problem (CP) Using the Technique

As indicated above, the general problem CP at the core of all invention and discovery activity is to build bridges B, connecting two immense, ill-defined idea spaces (semantic nets) S and T:
S=space of real, familiar, concrete, simple, certain, and known ideas; and
T=space of imagined, unfamiliar, abstract, complex, uncertain, and unknown ideas.

Note that the target space T is even less well defined and larger than the source space S. T and S are immense, since they contain all domains of knowledge, including imagined ones (for T)!

Directly linking S to T is a daunting, unfruitful approach for the general CP. That is why almost all approaches to inductive reasoning deal only with micro-domains, limiting the sizes of S and T.

The technique's strategy for solving CP is to use only a third space I, linking S to T. Space I is a compact, mathematically well-defined space (I=IDEA graph) where the bridges B(I) are built.

Only element P(T) is needed from the space T, and a select few elements {Si} of S from multiple domains Di are needed. In contrast to successful academic approaches, the set {Si} is not a micro-domain of S, but single elements in several domains.

Geometrically:
S====B(I)====T

The construction of B(I) is possible, because we know something about the target idea being explored from space T: we know that P(T) holds true (a maximum belief inductive logic premise). When doing invention and discovery, we always know at least something P(T) about the idea we are exploring. It is presumed that one never invents with absolutely no goal or property in mind.

Knowing that P(T) applies, IDEA space I then provides other situations P(Si) for which P holds, and thus some ideas Si from S. The key is only a few Si are needed, no search through the entire space S is ever done.

The space I is small and well defined because of the abstraction requirement. All P in I must be abstract enough to be domain independent. Abstraction is economy of thought: there are only few truly abstract fundamental ideas (such as R=space, time, process, information etc.). Thus the space I in which bridges B(I) are built is (comparatively) small. The small space I implies that there are much fewer P than Si; however, only a few Si are needed to convey useful metaphors and analogies.

This strategy (called the maximum belief inductive logic), allows the technique to never deal directly with immense ill-defined spaces S and T, but only with, given P(T), P(Si) which are tiny, well-defined subsets of the whole spaces S and T.

### IDEA Space Complexity

Next is shown how small space I is, compared to all knowledge domains.

Complexity: Search Complexity<log(N×p)

| | |
|---|---|
| Tree Number | 30 < N < 60 |
| Tree Depth | d = 3 |
| Tree Branching | b = 5–10 |
| Tree Size | S = b\hat{ }d |

Perspectives Number Estimates:

Size Estimate: p=Number of Ps=10,000

Size Lower Bound: p=Number of Ps>m=30×5̂=3,750

Size Upper Bound: p=Number of Ps<M=60×10̂3=60,000

This number m<p<M of distinct perspectives P to explore T is sufficiently rich to capture the most important aspects of T, especially since the number of possible combinations of perspectives {Pi} used to represent ideas T is astronomical. Since each perspective is endowed with multi-domain metaphors and deep analogies, the technique has a huge potential for guiding the creative process of invention and discovery.

Note that even though, the numbers m, p, M are large, they are very much within computational efficient range as far as searches go, and infinitesimal, compared to the sizes of spaces S or T, whose complexity is of the order of the human brain.

This size reduction is due to abstraction (economy of thought): all IDEA concepts P are required to be abstract enough to be trans-domain and stem from N fundamental representations (N<60; d<4 on average).

Abstraction (giving rise to the mean complexity bounds N<60; d<4) makes the technique computationally efficient.

### IDEA Learning

There are two modes of operations: exploitation and learning. In the exploitation mode (mode II), the Cooperative Discovery Agent (CDA) suggests perspectives, parallel metaphors and analogies a user can use for invention and discovery. CDA guides creativity via metaphors and analogies, which depends on the acquisition and structuring of prior knowledge elements Si about a domain Di. In the learning mode (mode I), CDA interacts with a knowledge source (human or agent) to acquire specific knowledge elements Si of domains Di in S (specified by the maximum belief inductive logic heuristics).

CDA's modes of operation can be summarized as follows:

Mode I provides knowledge structuring. In mode I, maximum belief inductive logic, guides CDA in maximizing the Belief (Inductive Probability) it has in its own conclusions by:
(a)—guiding the user to maximally specific perspectives P (argument premises), and to input a specific concept S from a domain D;
(b)—selecting maximally general statements Q(S) about the concept S;
(c)—within each perspective P in IDEA, accumulating as many statements Q(S) from as many domains D as possible (cumulative supporting evidence); and
(d)—requiring a specific relationship d(P,Q) between the perspective premise P and the statement Q(S). d is called a “determination”.

Properties (a, b, c, d) classify maximum belief inductive logic as a hybrid determination-based analogy and as a simple induction type logic. The implementation of maximum belief inductive logic maximizes both “belief” and mental bridge B strength. In this sense, B spans both logic and cognition.

Mode II is innovation/discovery. In mode II, some leeway is given to the user to select a conclusion of maximal inductive probability (weakest, most general Q), or conclusions of more creativity (stronger, more specific Qs).

### Fundamental Maximal Creativity Requirements:

There is a requirement that the technique possess a maximal creativity reservoir. To this end, IDEA space I satisfies two requirements:
(R1) Any knowledge domain Di must be able to participate within any given context C and perspective P in IDEA; and
(R2) Any agent (human or software) with relevant knowledge must be able to contribute, within a context C and P in IDEA.

Condition (R1) is satisfied because IDEA lexicon is abstract and universal (domain-independent), and thus so are the contexts C and perspectives P. By construction, each perspective P in IDEA can accommodate elements Si from any domain Di, so that P(Si) is a metaphor to P(T). This condition ensures cross-domain fertilization between parallel metaphors, making them collectively more powerful as sources of understanding and analogies.

Condition (R2), on the other hand, allows learning to proceed in two possible ways:
(L1) Using CDA to guide people in selecting knowledge elements from a domain, via the maximum belief inductive logic heuristics; and
(L2) Using a domain Di agent Gi, that searches domain sources (e.g., via Natural Language Processing NLP) for elements Si, guided by the maximum belief inductive logic heuristics.

Condition (R2) allows many potential knowledge sources, and in particular, allows mass cooperative creativity (e.g., Wikipedia, Linux, YouTube, MySpace, Human Genome Project etc.) Requirements (R1) and (R2) (all domains, all agents) ensure that the greatest potential reservoirs of knowledge are available for the maximum belief inductive logic inferencing.

IDEA perspectives P are local contexts that satisfy (R1) and (R2), to enable the maximum belief inductive logic to be interpreted as local heuristics for selecting the bridges that solve the CP. The selected bridges are:
(B2) parallel multi-domain metaphors; and
(B3) deep analogies.

### The Maximum Belief Inductive Logic Process

The maximum belief inductive logic refers to the following strategies:
(S1) Maximize the number and strength of the bridges in Bi, to increase the belief the agent CDA has in its own metaphors and analogies; and
(S2) Maximize the Belief B in (Inductive Probability of) the inductive argument used to construct the analogies.

Strategy (S1) contributes to the logical condition (S2) by increasing the potential number of parallel metaphors and inferencing premises. Both S1 and S2 are integrated into maximum belief inductive logic.

Instead of attacking the idea T directly, the technique first uses IDEA to split T into its component perspectives {P(T)} within well defined cognitive contexts C (C=paths in IDEA graph). Each perspective P(T) offers a unique representation R, and context C for exploring T.

The maximum belief inductive logic then uses a single global strategy, which is interpreted by the local context C and perspective P in IDEA, as local heuristics {Hi} for building B2 and B3.

The maximum belief inductive logic is the tool the technique uses to guide the creative process of using metaphors and analogies, within cognitive contexts. The maximum belief inductive logic provides an optimal form of creativity: creativity with maximal logical strength (maximal inductive probability, given the constraints) of its conclusions. The maximum belief inductive logic provides the heuristics to build mental bridges B of maximal strength, to solve a Creativity Problem (CP). As indicated above, all creative innovation, invention, and discovery activities share the creativity problem (CP) at their core: to construct a set B of mental bridges, enabling someone to:
(1) Explore an imagined idea T, using the real S
(2) Explore an unfamiliar idea T, using the familiar S
(3) Explore an abstract idea T, using the concrete S
(4) Explore a complex idea T, using the simple S
(5) Explore an uncertain idea T, using the certain S
(6) Explore an unknown idea T, using the known S

Typically, operations {(1), . . . , (6)} are simultaneously needed for a single creative solution (e.g., T=a new policy strategy). The maximum belief inductive logic is required to be able to cope with this demanding situation: parallel bridges (parallel multi-domain metaphors) are used to enable explorations {(1), . . . , (6)} simultaneously.

The key human mental tools for solving (CP) are representations, inductive logic, metaphors and analogies. The technique uses representations and a special form of inductive logic, called the maximum belief inductive logic, to solve (CP) in a logically optimal way.

The technique uses the maximum belief inductive logic to build mental bridges B={B1, B2, B3} that move the mind from known source ideas S, to a new target idea T under exploration:
(B1) Multiple Perspectives, Representations of T (in IDEA);
(B2) Parallel Multi-Domain Metaphors about T; and
(B3) Deep Analogies/Inductive Inferences related to T.

The technique solves the Creativity Problem (CP), by enabling an agent (human or artificial) to build the set of bridges B={B1, B2, B3}, by providing specific local heuristics for constructing B. The maximum belief inductive logic ensures that the bridges B can have maximal logical inductive strength, if so desired. An option at the opposite extreme is to have B endowed with maximal creativity. The maximum belief inductive logic, interpreted in different contexts C, gives rise to a vast number of local heuristics for building bridges B.

The maximum belief inductive logic strategy is the reason requirements {R1, R2} are imposed on IDEA's learning. By maximizing the potential size of the creative knowledge reservoir, strategy (S1) can be used.

Instead of attacking the idea T directly, the technique first uses IDEA to split T into its component perspectives {P(T)}within well defined cognitive contexts C. These cognitive contexts C are IDEA. Each perspective P(T) offers a unique representation R, and context C for exploring T. The maximum belief inductive logic then uses a single global strategy which is interpreted by the local context C and perspective P in IDEA, as local heuristics {Hi} for building B2 and B3. The local heuristics {Hi} are adapted to each local cognitive context C and perspective P within IDEA. There are thousands of such local contexts C/perspectives P in IDEA. In this sense, the maximum belief inductive logic is a global meta-heuristic, which is locally interpreted by the context C and P, as locally adapted heuristics {Hi}. An agent (human or artificial) can use the heuristics {Hi} for building B2 and B3. Within each perspective P (and its context C), the technique enables the user to build the mental bridge B2, then B3 using B2. The bridge construction process is done using a general strategy called the maximum belief inductive logic in the form described next.

### The Maximum Belief Inductive Logic Form:

A target idea T is being explored, from a given representation R, context C, perspective P(T), in IDEA. The maximum belief inductive logic is a hybrid determination-based analogical reasoning (DBAR) analogy/simple induction. In essence, this is a inductive logical argument of the form:

Premises:

| | |
|---|---|
| T, P(T) | Target idea T, Perspective P in I |
| Si, P(Si) | Parallel Metaphors from domain Di in S; i = 1, . . . , m. |
| Qi(Si) | Generic Source Analog i = 1, . . . , m |
| d(P, Qi) | Determinations i = 1, . . . , m |
| Q (Sj) | Selected Source Analog |

Conclusion:

| | |
|---|---|
| Q(T) | Inductive Hypothesis about T |

where:
   T is the target idea under exploration, with a known property P(T).
   S is the source idea space, partitioned in many knowledge domains Di. S is a vast space. Only a few elements Si from S are needed.
   Si is an element of domain Di in S, satisfying P(Si); i=1, . . . , m; parallel metaphors for {T, P(T)}. The set M={S, P(Si)} of parallel metaphors form the basis for building B3.
   The more domains Di and elements Si have both properties P and Qi, the greater the argument strength (simple induction). Increasing the number m of parallel metaphors {P(Si); i=1, . . . , m} allows the potential for a stronger argument.
   The specificity (but abstractness) of the similarity P between Si and T, makes the overall inductive argument stronger. The longer the path C, between R and P, the more specific P becomes, the stronger the premises P(T), P(Si) become. At the same time, the more abstract P is, the “deeper” the analogy tends to be. A balance between these competing needs is achieved.
   Qi(Si) is a property of element Si related to P(Si) by d(P, Qi); i=1, . . . , m; See heuristic H2, which imposes a degree of relevance d (called a “determination”) of P to Qi.
   The determinations d(P, Qi) justify (strengthen) the inductive hybrid analogy/simple argument [3].
   Q (Sj) is maximizing a property among the set {Qi(Si)}. See heuristic H3.
   Inductive argument conclusion Q(T), the new property Q known to be satisfied by Sj, is transferred to the idea T.

The set of parallel metaphors M={P(Si)} shows the structural parallelism, or mapping between domains Di [Gentner 1983]. They are the relations that hold within each domain Di, seen from perspective P. They are one-to-one maps between multiple domains Di of S.

### The Maximum Belief Inductive Logic Rules

The technique operates in two modes:
Mode I Collective knowledge repository mode; and
Mode II Advisory mode.

In mode I, the maximum belief inductive logic provides the CDA agent (source of knowledge) with heuristics for finding specific domain knowledge elements S, and Q(S). CDA thus selects and structures domain knowledge elements, under the heuristics of the maximum belief inductive logic.

In mode II, the maximum belief inductive logic provides the user with two extreme options:

| | |
|---|---|
| 1 - Maximally strong bridges B | (The maximum belief inductive logic) |
| 2 - Maximally creative bridges B | (The minimum belief inductive logic) |

The maximum belief inductive logic rules interpreted within a context C and perspective P, gives local rules (heuristics), adapted to each local context {C}. The maximum belief inductive logic gives local heuristics to generate and select multi-domain metaphors and deep analogies, adapted to each context C and perspective P in IDEA. The context C and perspective P in IDEA, are used to interpret the maximum belief inductive logic rules into local heuristics H={Hi} adapted to C=R/P. Given C=R/P, the maximum belief inductive logic provides heuristics for three steps:
(1) Generation of a set M(T) of Parallel Multi-Domain Metaphor elements {Si, P(Si)}: heuristic H1. Given the set M(T) of metaphors for T, the maximum belief inductive logic interpreted locally, translates into local heuristics H2, H3, H4;
(2) Generation of source analog Qi(Si): heuristic H2; and
(3) Selection of analogy Q(T): heuristic H3.

Local Heuristics {Hi; i=1, 2, 3, 4} of the maximum belief inductive logic, adapted to context C (perspective P, representation R) are defined as:
H1—Given a domain Di, select a key element Si of Di in S, satisfying the property P(Si), within the context C. When possible, add elements Si so that P(Si) is satisfied, but in an entirely new way from the P(Sj) already existing within P (node of I). This enlarges the number of ways P(Si) can be satisfied.
Maximize the number n, of domains Di in S; (i=1 . . . , n), in which Si is selected (for maximal cross-fertilization). Di are chosen from the domain lexicon D
H2—Within the domain Di, select the key properties qj of Si that result from perspective P(Si). Select property statements qj such that one or more of the following d(P, qj) applies:
d(P, qj)=
   Property qj of Si stems from property P(Si)
   Property qj of Si enables property P(Si)
   Property qj of Si is relevant to property P(Si)
   Property qj of Si solves the problem P(Si)
   Property qj of Si is closely related to P(Si)
   Property qj of Si is implied by P(Si)
   Property qj of Si is equivalent to P(Si)
within the context C=R/P in IDEA.
Maximize the number Np of such key properties qj; j=1, . . . , Np.
Abstract generic a (domain-free) statement Qj from each specific (domain-dependent) statement qj. This means, restate each statement qj, in a generic domain-free manner as Qj.
H3—Select a conclusion statement Q from the premise statement set {Qj}, using one (or more, within a class) of the following maximum belief inductive logic strategies:
Max Plausibility Strategies=greatest inductive probability=weakest conclusion:
MaxP0=Select Qi such that its Si is least different from T, from point of view of P: P(Si) is least different from P(T).
MaxP1=Select the weakest statement Q=Qmin within all domains Di.
MaxP2=Select statement Q=Qmax with greatest multi-domain validity (simple induction argument component).
MaxP3=Select Q as the disjunction (OR) of all statements Qi
Max Specificity Strategies=lowest inductive probability=strongest conclusion:
MaxS1=Select the strongest statement Q=Qmax within all domains Di.
MaxS2=Select statement Q=Qmin with lowest multi-domain presence.
MaxS3=Select Q as the conjunction (AND) of all statements Qj
The strategy is user selected, and depends on user needs. Other strategies will be added for broadening searches.
H4—Apply statement Q as the new conclusion Q(T) about the idea T under exploration.

### IDEA/The Maximum Belief Inductive Logic and Other Induction Models

The maximum belief inductive logic/heuristic has unique features, which include:
H1—Selection of the domains Di and sources Si is conditioned by the perspective P(T) and IDEA context C in which it resides. IDEA is a unique component of the technique.
H2—The mapping between T and S is not the causal structure from S to T (as in Structure Mapping Theory), but indirectly via a more abstract perspective P. Within each representation R, a different type of structure is mapped. The nature of that which is mapped from S to T, depends on P and its context C. Each basic representation R in IDEA provides a unique context C to P, and thus transfers a unique structure, not only causal structure. The property Qi is selected by the perspective P(Si) and its context C. Heuristic H2 endows a degree of relevance of P to Q (i.e., a determination d(P, Qi)) determined by the perspective P. The type of relevance is selected by the perspective P and its context C within IDEA.
H3—The inclusion of several domains Di with elements Si having property Qj, makes the maximum belief inductive logic argument a hybrid determination-based analogical reasoning (DBAR) analogy/simple induction argument, where T is compared to several objects Si.

The maximum belief inductive logic has some elements of powerful analogy models, but each is unique. The elements of analogy models are:
As in Structure Mapping Theory, elements of Qi are being transferred to T, but which is transferred is not only causal relations, but depends on the context C in IDEA representation R, in which the perspective P resides. Hence the words “enables, solves, stems from” are used depending on C.
As in DBAR analogy, a determination d(P,Qi) is added as a premise to increase the Inductive Probability of the overall logical argument. But the nature of the determination depends on the perspective P and its context C, as specified by heuristic H2.
As in Minsky's (p) analogies, parallel metaphors (Qi(Si); i=1, . . . , n) are considered, but they are selected by the maximum belief inductive logic Rules. The parallel metaphors only serve as stepping stone to creating a deep analogy/inductive inference, as specified by heuristic H3.
As in Hofstadter's Slippage Model, there are abstraction-concretization steps, similar to his “Export Slippage” and “Import Slippage” in connecting metaphors and analogies via their more abstract common perspective P. The transport from idea S to idea T is similar to the “Transport Slippage” allowing the metaphor P(S) to P(T). In the maximum belief inductive logic, Transport and Import slippage are done in a single step from the given perspective P to the domain Di element Si, and there is no explicit export slippage step, since T is only implicit, while P is the starting point.
No bayesian learning is currently included in the maximum belief inductive logic, but will eventually be fitted into the strategies {Hi}.

The maximum belief inductive logic is a unique form of inductive logic combining the strengths of several elements (Structure Mapping, Determinations, Slippage and Parallelism), but includes unique elements (Prior decomposition into abstract universal perspectives, transfer of non-causal structure, context dependent determinations, multi-domain parallel metaphors and analogies). These unique elements give the maximum belief inductive logic its flexibility, and the computational power to use collective cooperative creativity.

The power of the maximum belief inductive logic results from the global strategy of Maximizing the Inductive Probability by:
(1) Maximizing the premise strength by premise specificity P(T) within a more abstract context C in IDEA.
(2) Maximizing premise strength by adding a determination premise of form d(C/P, Qi), ensuring relevance of property Qi. This is done using an agent (human, but potentially artificial intelligence).
(3) Maximizing the number of domains Di; i=1 . . . , n where the new property Qi is shared (simple induction argument for parallel metaphors, included into the analogical argument by H3).
(4) Minimizing conclusion strength by selecting the weakest conclusion. The weakest conclusion is the least specific conclusion selected by H4.

In addition, the maximum belief inductive logic is inseparable from IDEA knowledge structure (a process upper ontology).

### Implementation

Implementation provides an algorithm flow in an IDEA graph, guided by the maximum belief inductive logic strategy. The technique functions in two cooperative modes:
1. Knowledge Structuring Mode I: a user inputs knowledge about an idea T from a domain Dj, when T is seen from perspective P(T), and represented by R in IDEA.
The user is guided by heuristics H1, H2 above.
IDEA serves as a discovery knowledge base DKB, with uniform structured environments (representations R, perspectives P).
2. Advisor Mode II: a user-CDA dialog guides the user to explore his/her idea T in:
   choosing a representation R for T (R is a tree root in IDEA).
   choosing a perspective P(T) from which to study T within R
   learning metaphors M from node P(T) in IDEA
   learning an analogy Q(T) from node P in IDEA.
The technique is guided by rules H3 or H4 above.

### Code Objects and Structures:

IDEA is required by the maximum belief inductive logic strategy to offer perspectives P (tree nodes) as specific as possible to maximize inductive strength of analogies, while still remaining domain independent. This results in an average depth of 3 or less. The ability to remain domain independent permits discovery in cross-disciplinary metaphors.

The size of a tree is less than the order of 10̂=1,000 perspectives P, so A*-like heuristic searches in any tree are highly efficient. Each tree is defined by its root R (representation) name.

There are currently N=35 trees in IDEA. Each tree represents a coarse perspective on a user-selected idea T. So each idea T can be explored from N=35 distinct fundamental points of views. This decomposition plays several roles: divide & conquer, multi-perspectives, and specificity of perspective on the idea T to maximize inductive strength.

IDEA has leaves M, as parallel multi-domain metaphors, attached to each perspective P. Each leaf is a hash containing metaphor and analogy elements Si and Q from a domain. Thus IDEA is a mix of hierarchical/relational (tree/leaf node hash) structure. The hierarchical/relational structure can be efficiently coded in either a pure object language, such as RUBY or Java, or in a mix of object and code, such as XML.

The maximum belief inductive logic strategy provides heuristics to guide either the user (input mode) or the technique (advisory mode) in selecting proper metaphor and analogy elements.

### Cooperative Discovery Agent (CDA):

The agent is best described as a “cooperative discovery agent” (CDA). The CDA is encoded as a Finite State Machine (FSM) over the IDEA ontology. There are three FSMs (mode I, mode II, CoSolver mode). Each FSM is defined by its states, state behaviors, and state transition rules.

The reference to a “cooperative discovery agent” (CDA) is made because the CDA extends beyond traditional database functions. In contrast with a search engine, the CDA is not limited to search engine functions, and in some embodiments does not search the Web or otherwise perform a traditional search. In some embodiments, CDA does not provide data mining functions. CDA is different from an expert system, and generally does not mimic a domain expert. CDA is not a tutoring system. CDA is not a database because it doesn't store extensive data to query.

CDA is not an inference engine because it generally does not perform inference chains. In contrast, CDA enables networked one-step inductive inferences, as opposed to chains performed by Inference Engines.

IDEA serves as a combination process ontology and discovery knowledge base (KB). The process ontology is the static backbone (math graph), while the KB is cooperatively enriched in CDA's knowledge structuring (mode I). CDA's mode I is “cooperative” because CDA actively guides the user (using heuristics and a Q&A dialog) in:
(a) exploring IDEA perspectives P
(b) selecting a concept S from domain D
(c) selecting a statement Q(S) about S,
   while the expert user provides the domain expertise (S, Q(S)) from domain D.

CDA does not provide NLP (natural language processing) or statistical functions in its primary function. Eventually, with the help of an NLP agent, CDA may autonomously search the Web for S and Q(S) in domain D (without a human user). CDA will then involve human users only in mode II (Innovation/Discovery).

CDA is complementary with the above tools, and will become synergic with them as Internet technologies such as Web 3.0 develop.

The CDA is efficiently encoded as a Finite State Machine (FSM) in object code, having few distinct states (behaviors) in each of the two pseudo-algorithms below. Beginning users will be guided by Domain Maps that walk them through concrete examples.

### Cooperative Discovery Agent's (CDA's) Activity:

All of the CDA's activity can be summarized as follows:

maximum belief inductive logic+IDEA=>Knowledge Structuring+Innovation

This is provided as two modes of operation, so that the above can be presented as:

maximum belief inductive logic+IDEA=>Knowledge Structuring+Innovation
(mode I)=>(mode II)

The CDA is essentially guided by a unique logical principle (called maximum belief inductive logic): to maximize its own “Belief” (the term used for Bayesian Inductive Probability) in its discovery conclusions.

One may take the logical rationale that Premises P entail a Conclusion Q. Therefore, in inductive logic, maximal inductive probability of a conclusion Q is obtained by making the premises maximally strong (i.e., P as specific as possible), and by making the conclusion maximally weak (i.e., Q as general as possible). In CDA this strategy is encoded as maximum belief inductive logic: the Belief=Inductive Probability of the conclusion Q, depends on the relative strengths of statements P and statement Q.

### Maximum Belief Inductive Logic Structures:

IDEA requires maximum specificity of perspectives P, while satisfying the constraint of abstraction (remaining a trans-domain ontology). This maximizes the specificity of the argument premises P, and thus the inductive probability (the chosen perspective P is used as a premise). CDA maximizes the specificity, determination and number of domain knowledge elements {S, Q(S)} used as premises in CDA's logic argument. CDA's behavior is entirely guided by a single maximization principle: CDA attempts to maximize the belief it has in (inductive probability of) its own conclusions, while satisfying the constraints of trans-domain abstraction.

### Knowledge Repository Mode Pseudo-Algorithm Example

Pseudo-Algorithm Flow: The following is an example of the technique dialog. Example words used in the technique for human interface functions are quotes.

The algorithm should (approximately) follow this sequence:
1—“Input the name of the idea T?”; read (T);
“Input the name of the domain Dk of T from Lexicon D”;
Display (D);
Read (Dj);
2—“Select a representation R (from a tree in IDEA) for T”;
Explain what a representation is; give concrete examples;
Display (R) from IDEA tree roots;
Read (R);
3—Given a representation R, do a user-guided heuristic (A*-like) search in tree of root R, to choose of a specific perspective P(T) (node in tree) within R. The user provides the selecting heuristic function.
4—“Select the elements Si within domain Dk, that are central within Dk to the perspective P. (e.g., the element Si=Firewall of the domain Dk=Computing is central to the perspective P=Shield/Information; so are Si=Password, Si=SiteKey, Si=UserID etc.)”
“Follow the maximum belief inductive logic strategy heuristics H1:
H1=Given the domain Dk, select a key element Si of Dk in S, satisfying the property P(Si), within the context C. When possible, add elements Si so that P(Si) is satisfied, but in an entirely new way from the P(Sj) already existing within P (node of IDEA). This enlarges the number of ways P(Si) can be satisfied.”;
Give concrete examples already in node P(T) if there are some;
Read (Si);
Create a new leaf (Si) (a hash) attached to node P of tree R in IDEA;
Assign to leaf the name leafname: =“Si(Dk)”;

### The Maximum Belief Inductive Logic Strategy—Analogy Selection & Generation Rules:

5—“Select only properties qj(Si) of element Si that result from the perspective P(Si)”;
Give concrete examples already in P(T) if there are some;
“Follow heuristic H2 to select qj(Si)”:
H2=Within the domain Dk, select the key properties qj of Si that result from perspective P(Si). Select property statements qj such that one or more of the following d(P, qj) applies:
d(P, qj)=
   Property qj of Si stems from property P(Si)
   Property qj of Si enables property P(Si)
   Property qj of Si is relevant to property P(Si)
   Property qj of Si solves the problem P(Si)
   Property qj of Si is closely related to P(Si)
   Property qj of Si is implied by P(Si)
   Property qj of Si is equivalent to P(Si)
within the context C=R/P in IDEA.
Maximize the number Np of such key properties qj; j=1, . . . , Np.
Abstract a generic (domain-free) statement Qj from each specific (domain-dependent) statement qj. This means, restate each statement qj, in a generic domain-free manner Qj”;
Give concrete examples of d(P, qj);
6—Read (Qj(Si));
Store (Qj(Si) in leaf (hash) Si(Dk) attached to IDEA node P in tree R;
7—Quit;

The above steps are discussed in greater detail as follows:
Step 1: The lexicon D contains specific knowledge domain Dk names ARCH (architecture), BIOL (biology), BIOM (biomedical), BIOC (biochemistry), etc. Any knowledge domain Dk can participate in sharing insights on a specific perspective P.
Step 2: The multiple representations R (among the N in IDEA) form the first bridge B1 (associating the space S to space T) to solve (CP).
Step 3: The maximum belief inductive logic strategy requires maximum specificity of perspective (maximum inductive probability of inferences), under the constraint of remaining trans-disciplinary (to enable all domain participation). This abstraction limits the tree depth to 3 or 4.
Step 4: The concept Si in domain Dk provides a metaphor P(Si) for P(T) seen from perspective P, within the representation R. This concept Si provides a metaphor P(Si) for building bridge B2 from space S to space T.
Step 5: This step will strengthens the analogies by adding a “determination” d(P,Q) to the argument premises. This is demanded by the maximum belief inductive logic strategy format. This step provides the building blocks for building bridges B3 from space S to space T.
Step 6: This step inputs analogy elements Qj(SI) of domain Dk, into the (hash) leaf Si(Dk). These (hash values) elements can then be efficiently retrieved by their hash keys, when in the advisor mode. Several domains Dk can participate to enrich each perspective P(T). This enables the cooperation of many agents, with different expertise domains (Wiki style, but with perhaps more control).

A future NLP-driven Web agent, may eventually replace human input sources, by autonomously interpreting the heuristics H1, H2 within an IDEA context C.

### Advisor Mode II Pseudo-Algorithm

The algorithm for the advisor mode should (approximately) follow this sequence:
1—“What is the name T of your idea?”. Read (T);
2—“Which representation R would you first like for ‘T’?”;
Explain what a representation is; give examples;
Display (R) from IDEA tree roots;
Read (R);
3—Use a heuristic (A*-like) search to help the user select a perspective P(T) from which to explore the idea T, within the representation R; The maximum belief inductive logic strategy constrains each tree of root R in IDEA is shallow (mean depth=3).
4—“Here are some metaphors for idea T seen from perspective P”;
Display the parallel metaphors Si, P(Si) for T, P(T) stored in the P node's leaves (hashes);
5—“Do you want a maximally strong analogy (strongest inductive probability) regarding T, or a maximally creative one (weakest inductive probability)?”
Read (choice);
6—if (choice=maximally strong) display Q using one of the rules H3;
H3=Select statement Q=Qmax from all leaves (hashes) attached to node P, with greatest multi-domain Dk presence (simple induction argument component).
   Select Q as any combination AND/OR of all statements Qj in the leaves (hash) attached to node P in tree R.
if (choice=maximally creative) display Q using one of the rules H4;
H4=Select statement Q=Qmin with lowest multi-domain presence.
   Select Q as the conjunction (AND) of all statements Qj in the leaves (hash) attached to node P in tree R.
   Intermediate strength choice would take a specific AND/OR combination of Qi S.
7—“You can use statement Q(T) applied to your idea T, and interpret it either as a:
   Suggestion Q(T) about T you can work with (Invention), or a
   Hypothesis Q(T) about T you can try to support or refute (Discovery)”;
8—Suggest to loop back to step 3 to select a new perspective P′(T) in the representation R, if so desired;
9—Suggest to loop back to step 2 to choose a new representation R′ for T, if so desired;
10—Suggest to enter a new idea T to explore (step 1), if so desired;
11—Quit;

### General Functionality

The following describes the various stages above. Steps 1, 2, 3 comments are identical comments provided in the previous section.
Step 4: The multi-domain parallel metaphors P(Si) for P(T) (values of hash leaves attached to node P) provide the second bridge B2 between spaces S and T.
Step 5: The maximum belief inductive logic strategy translates a metric of inductive logic (Inductive Probability), into measurable metrics about the IDEA graph. The maximum belief inductive logic strategy form is a hybrid analogy/simple induction:

| | | |
|---|---|---|
| T, P(T) | | Perspective |
| Si, P(Si) | i = 1, . . . , n | Parallel Metaphors |
| d (P, Q) | | Determination |
| qj(Sj) | j = 1, . . . , m | Prior-Knowledge |
| | | Generalization |
| Q(Sj) | | General Property |
| | | Analogy |
| Q(T) | | Hypothesis |

The maximum belief inductive logic strategy is to maximize the inductive probability, of this argument, through all the degrees of freedom available:
a—premise truth:

| | | |
|---|---|---|
| P(T) | recognized property in idea T | |
| P(Si) | empirical truth (prior knowledge) | (i = 1, . . . , n) |
| q(Sj) | empirical truth (prior knowledge) | (j = 1, . . . , m) |
| d (P, Q) | | |

b—Increasing the relevance of property P to property Q:
(usually referred to as “common sense”)
Increasing d(P, Q)=degree of relevance of P to Q The more the domains j for which Q(Sj) are varied, the more the greater d(P, Q), since the link d is domain independent.
c—Increasing the inductive probability of (the technique's Belief in) an inductive argument:
   by increasing the strength of the premise P (making it less probable)
      by increasing the number of common properties P
      by increasing the specificity of the common properties P
   by weakening the strength of the conclusion Q(T) (making it more probable)
      by increasing the margin of error of the conclusion Q(T)
      by making Q broader, less specific, more probable, for example:
      by choosing a property Q common to all the Si.
      by increasing the number m of cases where P(Si) leads to Q(Si)
d—Requirement of total evidence:
   No available evidence bearing negatively on the argument must be suppressed.

These factors are computed to evaluate the Induction's strength, and used by CDA to describe why it thinks the argument is weak or strong. The argument strength metrics depend on the properties of the IDEA graphs.

### Maximum Belief Inductive Logic Strategy

(maximum belief inductive logic strategy)={
1—Maximize {Length Path(P)}, given the abstraction constraints;
2—Maximize {m; (P(Sj), qj (Sj)) j=1, . . . , m};
3—Maximize {strength d(P, Q)};
4—Minimize {strength (Q(T))};}
Step 6: some freedom in the maximum belief inductive logic strategy element (4):
4—Minimize {strength (Q(T))}; is used for added flexibility.
Step 7: Depending on whether the user is a manager, lawyer, designer, engineer, architect, musician etc. (in the invent mindset), or a mathematician, scientist (in the discover mindset), the conclusion Q offered can be interpreted as an invention suggestion, or a discovery hypothesis.

FIG. 1 is a diagram depicting the concept of a transition between source ideas and target ideas. This depicts an example representation of CP. A source idea space S is used to provide a target idea space T. The technique uses the creativity and discovery problem (CP) is to build a set B of mental bridges connecting:
(a) The real S, to the imagined T
(b) The familiar S, to the unfamiliar T
(c) The concrete S, to the abstract T
(d) The simple S, to the complex T
(e) The certain S, to the uncertain T
(f) The known S, to the unknown T

The bridges B link two spaces of ideas: S (source) and T (target). While three bridges are depicted, the concept is to provide enough bridges to provide a significant transition from the source idea space S to the target idea space T. Typically, the bridges are simultaneously used for a creative thought or invention. The technique enables this construction of parallel bridges B to solve CP without the impossible construction of the immense ill-defined spaces S and T themselves.

CDA guides the creativity and discovery process by the use of inductive logic. Logic ensures that the bridges B have high (inductive) strength.

The most potent and natural mental tools we have as bridges B between spaces S and T.

By way of example, one can implement three bridges B1, B2 and B3:
(B1) Multiple Representations, Contexts, Perspectives
(B2) Parallel Multi-Domain Metaphors M(S) for T
(B3) Deep Analogies linking S and T

The bridges B={(B1), (B2), (B3)} enable the mind to move from known familiar source ideas S, to unfamiliar novel ideas T under exploration. It is advantageous to implement the technique by computer because with a large database, it becomes extremely difficult to accomplish this. The technique provides bridges for solving the problem CP. The technique satisfies two fundamental “maximal creativity and discovery” requirements implemented by IDEA space:
All domains S of knowledge can participate in cross-fertilizing any given idea T under creative exploration; and
Any agent (human or artificial) with the relevant knowledge can participate in the creative process.

The technique enables maximal creativity and discovery for solving CP by providing large space of idea contexts where cross-fertilizing of ideas occurs and an interface for allowing participation. This provides cooperative innovation logic, enabling all agents of all skill domains to participate in collective creativity and discovery.

FIG. 2 is a diagram showing a structure used to transition from source ideas and target ideas. The technique is used to transition from a source idea microspace S to a target idea microspace T. This is implemented by a logical interface between a user and the cooperative discovery agent (CDA). The CDA is encoded as finite state machines (FSM) over the IDEA ontology.

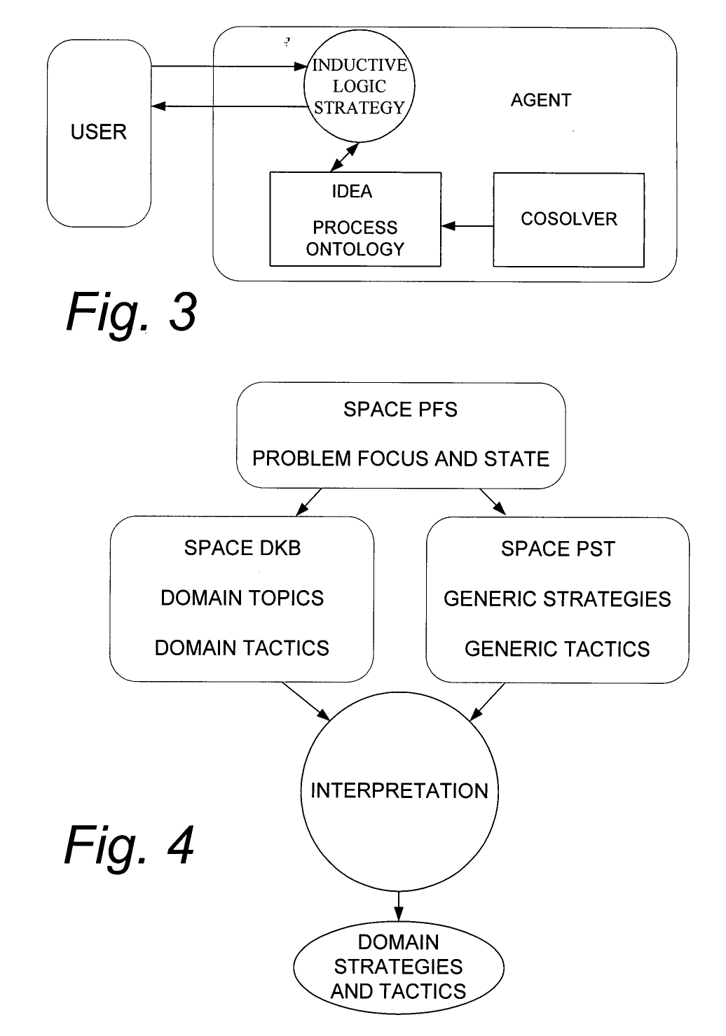

An example interface is depicted in FIG. 3, which is a diagram showing a logical interface between a user and the CDA. The user communicates a search request which is applied at the CDA to the maximum belief inductive logic. The maximum belief inductive logic uses IDEA to extract knowledge, for example from the cooperative problem solver module.

FIG. 4 is a diagram describing a logical data flow between a stated problem and focus and an expression of domain strategies and tactics. The problem is addressed in terms of a problem focus and state. A domain data space is defined consisting of domain topics and domain tactics. A generic data space for focus and state is defined consisting of generic strategies and tactics. The domain data space and generic data space are collectively interpreted, and domain strategies and tactics are developed from the interpretation.

### Cooperative Problem Solver Module:

The cooperative problem solver module is activated (in either modes I or II) when the user selects the representation “R=Problem” in IDEA. Problem is a unique representation in IDEA, focusing on convergent thinking (problem-solving) rather than on more divergent creativity. R=Problem thus requires its own unique methods/structures.

The cooperative problem solver module is presently geared to the domains of mathematics, sciences & engineering, but will be extended using the exact same approach to include all other domains in the IDEA lexicon D.

The cooperative problem solver module is a Cooperative Problem Solver in the technique's 2 modes:

Mode I—Knowledge Structuring: the technique collects and organizes bits of problem solving elements and organizes them into a coherent uniform framework exploitable by Maximum Belief Logic induction when in mode II.

Mode II—Innovation Advisor: In this mode, cooperative problem solver module is an advisor, guiding the user in becoming more aware of, and focusing the problem and to break it down to specific problem elements and topics.

### The Cooperative Problem Solver Module Structure:

The cooperative problem solver module is composed of 3 modules (Spaces):

| | |
|---|---|
| 1 - Problem Focus & State | (PFS Space) |
| 2 - Problem Strategy & Tactics | (PST Space) |
| 3 - Domain Knowledge Base | (DKB Space) |

### 1—PFS Space

The space PFS defines specifically what is meant by the current “state” of a problem at hand. Space S specifies the current status of the problem. At each moment in the status of a problem is a point (node) P in the space (graph) PFS.

As problem solving progresses, the point P moves in the space PFS (PFS is a multi-dimensional space). The problem state P is allowed to move freely in space PFS (problem-solving is not a linear sequential process (as is often assumed), but can be full of false starts, iterative refinements, cycles, and dead ends).

This freedom is a key property of the cooperative problem solver module approach: problem-solving here is akin to a free exploration game. The exploration involves motion in Space PFS, and associating patterns. PFS is spanned by 3 subgraphs {Si}
PFS=Span (S1, S2, S3), where
   S1=Problem Focus
   S2=Problem Phase
   S3=Problem Procedure

Each node P in PFS is defined by a combination of three nodes pi from the subgraphs Si:
P={p1 in S1, p2 in S2, p3 in S3}

In other words, a current problem focus & state P=
p1=a state of problem focus (what is the focus of the problem)
p2=a state of problem phase (what phase of problem solving)
p3=a state of problem procedure (what kind of difficulty, obstacle)

A point P in Space PST is specified by a set of activated nodes in the graph of PFS. P represents the current focus and state of the problem explored. The point P in Space PFS evolves continuously along with the problem exploration process.

### 2—PST Space

The space PST defines sets of generic strategies and tactics (actions) that can be used (associated with) in a problem state P in PFS.

The graph of PST is a set of trees. Each tree root is a generic strategy, while its nodes are generic tactics. Generic problem solving strategies (Tree roots in PST) are by way of non-limiting example:
Abstract
Analyze
Approximate
Assume
Classify
Decompose
Diagram
Estimate
Express
etc.

A point M in Space PST is a specified by a set of activated nodes in the graph of PST. A point M specifies a set of generic actions (strategies/tactics). Generic here means in a domain independent language.

The association PFS-PST specifies which set M of actions in PST are promising, given a problem focus and state P in PFS:
P(PFS)=>M(PST)
   (where => is not a logical implication, but an association).

The associations between space PFS and PST encode the heuristics of general problem solving. This approach views problem-solving as Learned Associations, between patterns of problem states and patterns of problem solving actions.

The point M in PST is a set of promising generic actions (Strategies/Tactics), the user is free to explore. This narrows down the possibilities (prunes the space PST), and thus facilitates problem-solving.

The set M is “promising” in a heuristic sense: many problems encountered in state P in PFS, have successfully been solved by taking actions from the set M in PST. A single point P in S is associated with a single point M in A, but a single point M in A does not represent a single action, but a set of promising actions.

The generic problem-solving strategies and tactics are of little help by themselves. They become powerful only when they become interpreted within specific domain and topics encoded in DKB.

Generic Strategies/Tactics become Domain Strategies/Tactics when interpreted within a location in the Space DKB.

### 3—DKB Space

DKB encodes hierarchical/relational information as a graph. Hierarchical data are trees with branches of the form:
Domain/Discipline/Class/Subject/

Examples of Domain/Discipline/Class/Subject/are
Domain/Discipline/Class/Subject/
Physics/QuantumPhysics/Process/QuantumDecoherence
Domain/Discipline/Class/Subject/
Physics QuantumPhysics/State/CoherentState

To the subject node are structured leaves (hashes) called Topics, encoding specific problem topics in the domain. These are specific Problem Topics, not the usual domain knowledge topics (as in usual books).
(e.g., Subject=QuantumDecoherence, Topic=Inhibition(QuantumDecoherence))

The trees are small, but the number of Topic leaves attached to each “Subject” twig can be very large. Since the leaves are uniformly structured (e.g., hashes), they are efficiently created, searched, stored, and retrieved.

Topics are small in the sense of being the smallest units of problems, not in the sense of being elementary or easy problem elements.

All Topics are uniformly structured for encoding specific relationships. Each Topic has at least two leaves, each leaf is a relational graph (e.g., hashes) with the following non-limiting structure:

```
Topic = {
    TopicSituations Hash
        Hash Keys:
        SituationBehavior
        SituationCausality
        SituationDynamics
        SituationFunction
        SituationGeometry
        SituationInformation
        SituationInteraction
        SituationLogic
        SituationMaterial
        SituationMotion
        SituationNumber
        SituationPattern
        SituationProcess
        SituationProperty
        SituationState
        SituationStructure
        SituationSymmetry
        etc.
    TopicRelations Hash
        Hash Keys:
        TopicConcepts
        TopicDimensions
        TopicEstimates
        TopicExamples
        TopicInsights
        TopicMetaphors
        TopicMethods
        TopicModels
        TopicRelations
        TopicRepresentations
        TopicScales
        TopicUnits
        etc.
}
```

The TopicSituation leaf serves to bind a given problem, to one or more problem Topics. This encodes application knowledge: which knowledge to apply in a given situation. This high-level type of knowledge is usually acquired through a long experience in a domain.

The TopicRelation leaf serves as domain and topic-specific problem solving guidance strategy output by the technique. This leaf encodes application knowledge, which is how to apply general knowledge to specific problem situations. This high-level type of knowledge is usually acquired through a long experience in a domain.

These two leaves enable sharing and using our collective experience on which and how to apply general knowledge, in any given problem situation, which is a distributed form (in both time and space) of cooperative problem solving.

### Pseudo-Algorithm for Knowledge Structuring (Mode I)

Step 1: The user wants to share a bit of problem solving knowledge in a Domain/Discipline/Class/Subject on a specific Topic. (e.g., MATH/Approximation/Magnitude/ErrorEstimates; Topic=Bounding of ErrorEstimates). The technique guides the user to the requested tree and node location in DKB.

If the topic or one of its elements does not exist, the user can suggest adding a new one in a suggestion box. The suggestion may be implemented by the organization responsible for the technique.

Step 2: The user inputs small elements of knowledge related to the specific Topic, as specified by the structure of the Topic relational graphs (defined above) {TopicSituations, TopicRelations}

### Remarks on Mode I:

Step 1: The cooperative problem solver module enables cooperation across all disciplines by providing a uniform structured environment for storing problem solving knowledge bits. Individuals with the proper skills can input their insights on specific problem Topics, in DKB in a uniform and structured manner.

The number of possible topic can be very large, while DKB trees remain small and static. The hash structure of leafs allows computationally efficient pattern searches, inputs, outputs, creations, deletions.

Step 2: The uniform structure of the topic leaves makes it easy for knowledge sharing that is distributed in both time and space (e.g., Web).

### Pseudo-Algorithm for the Innovation Advisor (Mode II)

Step 1: The user specifies a point P in Space PFS, under the technique's guidance via a user dialog. Point P represents the current focus and state of the problem explored by the user. This user input includes a structured ProblemSituation description. cooperative problem solver module output messages which the technique communicates to the user.

Step 2: The cooperative problem solver module suggest a generic set of actions (strategies/tactics) M from Space PST, associated with P in PFS.

Step 3: The cooperative problem solver module associates ProblemSituation description to TopicSituations, and thus to a specific set of domain Topics. This is done by a simple User Q&A and string processing. Advanced NLP methods will be incorporated here when available.

The Max(B) Logic Form of inductive argument specific to cooperative problem solver module is:
T=Problem, P(T)=Element Pattern in ProblemSituation
S=Topic, P(S)=Element Pattern in TopicSituations (matching P(T))
Q(S)=TopicRelations(Topic)
d (P, Q)={in most past instances, P(S)=>Q(S)}

Conclusion Q(T)

Step 3: The cooperative problem solver module suggests a Domain/Topic—specific set of associations Q(S) in the TopicRelations leaf. The suggestions Q(S) with greatest scope form the conclusion Q(T) of an inductive argument with greatest strength.

Step 4: The user uses this key information to advance the problem focus and state. Go back to Step 1, unless Quit is desired.

### Remarks on Mode II:

### Steps 1 & 2:

In cooperative problem solver module, a problem state pattern is specified by three dimensions (made of finer sub-dimensions):
1—Problem Focus (e.g., domain, discipline, subject, element, topic, goal etc.);
2—Problem Phase e.g., (exploration, determination, computation, verification, abstraction, etc.); and
3—Problem Procedure (e.g., difficulty type: what, when, which, how etc.).

The cooperative problem solver module suggests associations between a given problem state in PFS and a set of problem solving actions in PST.

The cooperative problem solver module both engages and guides the user to actively:
1—Search for and identify problem state patterns; and
2—Associate the identified problem pattern to promising actions to take

The user is actively involved in the process, interacting with cooperative problem solver module as an advisor.

The ultimate source of the learned associations is the collective insights input into DKS, on the basis of our collective real-world experience, collected and organized by cooperative problem solver module in Mode I.

### Step 3:

The cooperative problem solver module facilitates the learning and execution of solving problem, at four levels of understanding within any knowledge domain:
1—Level of concepts (encoded in DKB trees)
2—Level of concept relationships (encoded in DKB trees)
3—Level of associating concepts/relationships with problem elements (S, P(S)<=>T, P(T))
4—Level of how to apply specific sets of concepts/relationships together (encoded in Q(S)).

Levels 1 and 2 are enabled by the uniform highly structured (hierarchical and relational) organization of all domain knowledge in DKB. The emphasis here is providing a semantic context for each concept.

Levels 3 and 4 are enabled by learning to associate patterns in the problem state to patterns of promising actions (problem solving strategies/tactics). These skills are usually learned by a long experience in a domain of knowledge.

Levels 3 and 4 are enabled by TopicSituations and TopicRelations in Topic.

### Cooperative Problem Solver Module Pseudocode:

The cooperative problem solver module can be described in terms of logic states of a finite state machine, as follows:

```
# Define FSM States:
findProblemState
findGenericAction
findSpecificAction
# Initialize Current State:
currentState = findProblemState ;
ProblemState = null ;
GenericAction = null ;
SpecificAction = null ;
# Finite State Machine (State Behaviors + State Transition Rules)
switch ( currentState )
{
  case findProblemState :
    problemState( ) ;
    if ( ProblemState = done ) currentState = findGenericAction ;
  break ;
  case findGenericAction :
    genericAction( ) ;
    if ( GenericAction = done ) currentState = findSpecificAction ;
  break ;
  case findSpecificAction :
    specificAction( ) ;
    if ( SpecificAction = done ) currentState = findProblemState ;
  break ;
}
# FSM State Behaviors
# Cooperatively Determine Problem State
  problemState ( ) {
# Specify Problem Focus
    problemFocus( ) ;
# Specify Problem Phase
    problemPhase( ) ;
# Specify Problem Procedure
    problemProcedure( ) ;
  }
# Suggest Generic Actions
  genericAction ( ) {
# Suggest Generic Strategies
    genericStrategies ( ) ;
# Suggest Generic Tactics
    genericTactics ( ) ;
  }
# Suggest Specific Actions
  specificAction ( ) {
# Match Problem Situation to Topic Situation (allow NLP upgrade)
    bestMatchSituationToTopics ( ) ;
# Match Problem Elements to Topics (allow NLP upgrade)
    bestMatchElementToTopics ( ) ;
# Suggest Topic Relations
    displayTopicRelations ( ) ;
  }
# Quit CoSolver Back to IDEA
  quitCoSolver ( ) {
  }
# END OF COOPERATIVE PROBLEM SOLVER MODULE
```

### Example—Use of the Term “Barrier”:

It is possible for a concept to be basically different in two fields, such as “current” in electricity is different from “current” in terms of time. In other cases, concepts are substantially different in different fields but basically the same concept.

In an example the term “barrier” is searched. “Barrier” can consist of a number of concepts in different domains. In many cases the concepts in different domains are substantially different but are basically the same concept. By way of example, a biological barrier is substantially different from a military barrier or a barrier in civil engineering; however all of these barriers are basically the same concept.

Taking the term, “barrier” as a concept,

Step 1:
User: Biochemist searching for an efficient way for drug molecules to cross the blood-brain barrier. Drug delivery system design.

User Idea T=Barrier Crossing Process

Step 2: IDEA Representation R=Process

Step 3: Perspective P within R
C=Process/Transport/
P=BarrierCrossing

Step 4: Parallel metaphors:

metaphors Mi in hash attached to P=BarrierCrossing

| Hash Key | Hash Value |
|---|---|
| D1 | = BIOL (biology) S1 |
| | = ViralCellInfection M1 |
| | = P(S1) |
| | in D1 |
| | = BarrierCrossing (ViralCellInfection) |
| | in Biology |
| D2 | = CHEM (chemistry) S2 |
| | = CatalyticReaction M2 |
| | = BarrierCrossing (CatalyticReaction) |
| | in Chemistry |
| D3 | = MILI (military) S3 |
| | = ArmorPiercing M3 |
| | = BarrierCrossing (ArmorPiercing) |
| | in Military |
| D3 | = MILI (military) S4 |
| | = FortressPenetration M4 |
| | = BarrierCrossing (FortressPenetration) |
| | in Military |
| D4 | = PHYS (physics) S5 |
| | = QuantumTunneling M5 |
| | = BarrierCrossing (QuantumTunneling) |
| | in Physics |
| D5 | = SOCI (sociology) S6 |
| | = GlassCeiling M6 |
| | = BarrierCrossing (GlassCeiling) |
| | in Sociology |
| D5 | = SOCI S7 |
| | = UpperClassCeiling M7 |
| | = BarrierCrossing (UpperClassCeiling) in Sociology |

Step 6: Analogy elements stored in hash attached to P=BarrierCrossing

| Hash Key | Hash Value |
|---|---|
| Q1 = | In M1, a tough drill penetrates the barrier |
| Q2 = | In M2, a third object acts solely to lowers the barrier |
| Q3 = | In M2, a third object makes the object more compatible |
| | with the barrier |
| Q4 = | In M3, an object adapted to the barrier shield is used |
| Q5 = | In M3, an object adapted to the local environment is used |
| Q6 = | In M4, a trojan horse is used |
| Q7 = | In M4, an impersonating object cover is used |
| Q8 = | In M4, uncertainty in location is exploited |
| Q9 = | In M6, adapting to local behavior increases crossing odds |
| Q10 = | In M6, adapting to local appearances increases crossing odds |
| Q11 = | In M7, an adaptation (education, training) increases |
| | crossing odds |

A combination Q of the set {Qi} can be used as new strategy for T=(Blood Brain) Barrier Crossing in Biology.

The user can select:
maximal inductive strength Q=all AND/OR combinations of {Qi}
intermediate inductive strength Q=some AND/OR combination of {Qi}
maximal creativity Q=AND {Qi}

Note that in the pharmaceutical field, a combination of the Qi is used to design real blood-brain barrier crossing molecules.

This example is chosen simple for clarity, but the same process applies at any level of generality.

### CONCLUSION

The absolutist terminology used herein, e.g., “must”, “requires”, “always”, “all”, “never”, etc. is used in the sense of the underlying logic and should not imply that exceptions are precluded or limited implementation would be ineffective. The terminology is used to explain the underlying logical philosophy; not as a requirement for implementation and is not meant to imply that the concepts are mandatory. As such, the terminology is used merely to express the underlying concepts and is presented for clarity of explanation of these concepts and should not be considered as limitations on the scope of the invention. As with most implementations, the techniques herein are effective without following the “must” or “required” doctrines literally, and are generally more effective when implemented without being so constrained.

By way of example, the statement, “CDA's behavior is entirely guided by a single maximization principle” describes the underlying principle, and does not preclude the use of additional maximization principles in the implementation. Similarly, “Select only properties qj(Si) of element Si” explains a concept of selection and does not preclude modifying the selection according to a particular implementation in order to include other properties.

The techniques and modules described herein may be implemented by various means. For example, these techniques may be implemented in hardware, software, or a combination thereof. For a software implementation, the techniques described herein may be implemented with modules (e.g., procedures, functions, and so on) that perform the functions described herein. The software codes may be stored in memory units and executed by processors or demodulators. The memory unit may be implemented within the processor or external to the processor, in which case it can be communicatively coupled to the processor via various means.

The previous description of the disclosed embodiments is provided to enable any person skilled in the art to make or use the features, functions, operations, and embodiments disclosed herein. In particular, while logically limited examples are given, it is possible within the scope of this invention to expand the concepts beyond the logically limited examples. Various modifications to these embodiments may be readily apparent to those skilled in the art, and the generic principles defined herein may be applied to other embodiments without departing from their spirit or scope. Such variations include the combination of the described examples with other forms of discovery logic, reasoning and search strategies, even though such other techniques by themselves would be contrary to the present invention. Thus, the present disclosure is not intended to be limited to the embodiments shown herein but is to be accorded the widest scope consistent with the principles and novel features disclosed herein.

1. A method for storing a knowledge repository having uniform structured environments of representations R and perspectives P, the method comprising:
inputting a name of an idea T;
displaying a lexicon of domains D; and
inputting a name of a domain Dk of T from the lexicon of domains D.

2. The method of claim 1, comprising:
reading a modified name of a domain Dj, in which Dj contains Dk.

3. The method of claim 1, comprising:
selecting the idea T;
identifying a first characteristic class of the idea T;
identifying a second characteristic class of the idea T; and
selecting the name of the domain Dk based on the identified first characteristic class of the idea T and the identified second characteristic class of the idea T.

4. The method of claim 3, comprising:
identifying a first characteristic class of the idea T as a general classification of T; and
identifying a second characteristic class of the idea T as a modifier of T.

5. The method of claim 1, comprising:
selecting the idea T;
identifying a context of the idea T;
identifying a perspective of the idea T; and
selecting the name of the domain Dk based on the identified first context class of the idea T and the identified perspective of the idea T.

6. The method of claim 1, comprising,
given at least one domain instance Di, selecting a key element Si of Di in information space S, satisfying:
a perspective P(Si), within a context C;
in the case of availability of additional key elements Si, adding the additional key elements until satisfying P(Si), said additional keys added in a different manner from a preexisting property of P of a node I, P(Si), thereby enlarging a number of resolutions of P(Si);
maximizing a number n, of domain instances Di in S; (i=1 . . . , n), by selecting Si, thereby maximizing cross-fertilization and choosing Di from the domain lexicon D.

7. The method of claim 1, comprising:
within the domain Di, selecting a set of key property statements qj of Si that result from a perspective P(Si);
selecting property statements qj such that one or more of the following D(P, qj) applies:
D(P, qj)=
property qj of Si stems from property P(Si)
property qj of Si enables property P(Si)
property qj of Si has relevance to property P(Si)
property qj of Si solves a problem P(Si)
property qj of Si has a close relationship to P(Si)
property qj of Si is implied by P(Si)
property qj of Si has equivalency to P(Si)
within a context C=R/P;
maximizing a number Np of specific key property statements qj; j=1, . . . , Np, and
providing a generic domain-free statement Qj from each specific key property statement qj, thereby resulting in a restatement of a plurality of the specific key property statement qj, in the generic domain-free statement Qj.

8. A processor comprising circuitry for performing the method of claim 1, comprising said processor provided as a chipset including at least one monolithic integrated circuit.

9. A machine readable medium comprising instructions for performing the method of claim 1.

10. A method for exploring stored knowledge repository data having uniform structured environments of representations R and perspectives P, the method comprising:
selecting a term T;
inputting a conceptual representation R for the term T;
providing a perspective P(T) from which to study T within R;
classifying the representation R within a domain D;
extracting a metaphor M from R for P(T); and
using the metaphor to generate an analog from the domain D.

11. The method of claim 10, further comprising:
using the metaphor M to develop an analogy or inductive inference Q(T) for the term T.

12. The method of claim 11, further comprising:
using the analogy Q(T) to select a conclusion statement Q from a premise statement set {Qj} within the domain D; and
using one or more, of the following induction logic strategy M strategies within a class of plausibility strategies, wherein:
a greatest inductive probability equates to a weakest conclusion, by selecting a statement instance Qi such that a key element Si of the instance Qi differs from T, from point of view of P, such that a perspective of the key element P(Si) differs from the P(T),
selecting a weakest statement Q=Qmin within all domain instances Di,
selecting a statement Q=Qmax with a greatest multi-domain validity as a simple induction argument component,
selecting a conclusion Q as the disjunction (OR) of all statements Qj, and
selecting maximum specificity strategies such that the maximum specificity strategies equal a lowest inductive probability and a strongest conclusion,
selecting a strongest statement Q=Qmax within all domains Di,
selecting a statement Q=Qmin with lowest multi-domain presence, and
selecting a conclusion Q as the conjunction (AND) of all statements Qj.

13. The method of claim 11, comprising:
applying a statement Q as the new conclusion Q(T) concerning the idea T under exploration.

14. The method of claim 10, comprising:
within the domain D, selecting a set of key property statements qj of T that result from a perspective P(T);
selecting property statements qj such that one or more of the following D(P, qj) applies:
D(P, qj)=
property qj of T stems from property P(T)
property qj of T enables property P(T)
property qj of T has relevance to property P(T)
property qj of T solves a problem P(T)
property qj of T has a close relationship to P(T)
property qj of T is implied by P(T)
property qj of T has equivalency to P(T)
within a context C=R/P; and
extracting a generic domain-free statement Qj from each specific key property statement qj.

15. A processor comprising circuitry for performing the method of claim 10, comprising said processor provided as a chipset including at least one monolithic integrated circuit.

16. A machine readable medium comprising instructions for performing the method of claim 10.

17. Apparatus capable of at least one of storing a knowledge repository having uniform structured environments of representations R and perspectives P, and exploring stored knowledge repository data having uniform structured environments of representations R and perspectives P, the apparatus comprising:
a routine for at least one of selecting or inputting a term T;
a routine for at least one of accepting an input of a domain D or displaying a domain D; and
a routine for establishing a lexicon association between T and one or more domains Dk associated with the term T.

18. The apparatus of claim 17 comprising:
a routine for accepting the input of the term T;
a routine for accepting an input of a name of at least one domain D of said one or more domains Dk of T from a lexicon of domains D, where D contains Dk.

19. The apparatus of claim 17 comprising:
a routine for, after selecting the term T, accepting an input of a conceptual representation R for the term T;
a routine for providing a perspective P(T) from which to study T within R;
a routine for classifying the representation R within a domain D; and
a routine extracting a metaphor M from R for P(T), and using the metaphor to generate an analog from the domain D.

20. The apparatus of claim 19, further comprising a routine, responsive to a selection of idea T, identifying a first characteristic class of the idea T, identifying a second characteristic class of the idea T, and selecting the name of the domain Dk based on the identified first characteristic class of the idea T and the identified second characteristic class of the idea T.

21. Apparatus capable of at least one of storing a knowledge repository having uniform structured environments of representations R and perspectives P, and exploring stored knowledge repository data having uniform structured environments of representations R and perspectives P, the apparatus comprising:
means for performing at least one of selecting or inputting a term T;
means for performing at least one of accepting an input of a domain D or displaying a domain D; and
means for establishing a lexicon association between T and one or more domains Dk associated with the term T.

22. The apparatus of claim 21 wherein:
the means for performing at least one of selecting or inputting a term T includes a routine for accepting the input of the term T;
the means for establishing a lexicon association includes a routine for accepting an input of a name of at least one domain D of said one or more domains Dk of T from a lexicon of domains D, where D contains Dk.

23. The apparatus of claim 21 wherein:
the means for performing at least one of selecting or inputting a term T includes a routine for, after selecting the term T, accepting an input of a conceptual representation R for the term T;
the means for performing at least one of accepting an input of a domain D or displaying a domain D provides a routine for providing a perspective P(T) from which to study T within R and provides a routine for classifying the representation R within a domain D; and
the means for establishing a lexicon association provides a routine extracting a metaphor M from R for P(T), and using the metaphor to generate an analog from the domain D.
